(19) United States
(12) Patent Application Publication
(10) Pub. No.: US 2026/0287038 A1
(43) Pub. Date: Sep. 24, 2026

(54) Integrated Semi Active Valve Seat Plate

(71) Applicant: Advanced Suspension Technology LLC, Northville, MI (US)

(72) Inventors: Ilan ARTEAGA, Mañaria (ES); Alexander Alvarez Cendoya, Bilbao (ES); Veronica Diez, Bilbao (ES); Jose Ramon Martinez, Ermua (ES); Kenneth Llonch, Hasselt (BE); Miguel Angel Dominguez, Ermua (ES)

(21) Appl. No.: 19/568,991

(22) Filed: Mar. 17, 2026

(30) Foreign Application Priority Data
Mar. 18, 2025 (DE) 102025110343.7

(51) Int. Cl. F16F 9/34; F16F 9/16; F16F 9/32; F16F 9/516

(52) U.S. Cl. CPC F16F 9/34; F16F 9/16; F16F 9/3271; F16F 9/516; F16F 2222/12; F16F 2226/04; F16F 2228/066; F16F 2230/30; F16F 2234/02

(57) ABSTRACT

A valve housing assembly for a shock absorber system comprises a valve housing and a valve seat plate, the valve seat plate comprising: a first side, a second side opposite of the first side, an outer edge at corresponding circumferences of each of the first and second side, and an elongated hole between the first side and the second side; wherein a shape of the outer edge follows a shape of an opening of the valve housing; wherein the outer edge is configured to securely position the valve seat plate in the opening; wherein a surface of the first side follows an outer shape of the shock absorber; and wherein the surface of the first side is configured to fit onto the shock absorber.

### CROSS-REFERENCE TO RELATED APPLICATIONS

This application claims the benefit of German Application No. 102025110343.7, filed on March 18, 2025. The entire disclosure of the application referenced above is incorporated herein by reference.

### FIELD

The present disclosure relates to a valve housing assembly, a valve system, a shock absorber system, and a method for assembling a shock absorber system.

### BACKGROUND

Shock absorber systems may comprise valves besides a shock absorber. The valve can help to lead the flow of liquid (damping fluid) displaced when a shock is absorbed. The assembly of the valve to the shock absorber may be complicated and/or it may limit the possibilities of the final shock absorber system.

Document DE 195 27 849 C1 shows a vibration damper having a damping cylinder filled with damping fluid and containing a piston dividing it into two working spaces, and a controllable bypass valve system to set the damping force, inside its own casing and linked to the damper by at least one flow connection. The flow connection is inside a tubular transition body between the valve casing of the bypass valve system and the vibration damper. The transition body centers at least one support body, which has at least one through passage for the flow connection.

Document CN 2 17 440 670 U shows a manual and automatic integrated regulating valve which comprises an oil storage pipe, a manual regulating valve assembly arranged on the oil storage pipe, an oil storage cavity arranged between the oil storage pipe and a bypass sealing pipe, a piston working cylinder installed in the bypass sealing pipe, a piston cylinder lower cavity arranged on the piston working cylinder, and a bottom valve structure installed at the lower end of the piston working cylinder. A bypass sealing pipe sealing ring is arranged between the bypass sealing pipe and the piston working cylinder.

Exemplary drawbacks in known systems lie in the assembly process. In order to assemble the valve seat plate within a valve assembly, it is introduced coming from above, i.e. from the side of the valve housing, before the individual parts are fixedly attached together. The diameter of known systems, however, is relatively small. Therefore, known valve seat plates comprise relatively small inner holes, which is partly due to outer geometry limitations. Because of the relatively small inner holes, the resulting flow areas for damping liquid is decreased, as well.

### SUMMARY

The above task and further problems are solved by a valve housing assembly according to the appended independent claims. The dependent claims relate to preferred embodiments of the disclosure.

The present disclosure relates to a valve housing assembly for a shock absorber system, the valve housing assembly comprising a valve housing and a valve seat plate, the valve seat plate comprising: a first side, a second side opposite of the first side, an outer edge at corresponding circumferences of each of the first and second side, and an elongated hole between the first side and the second side; wherein a shape of the outer edge follows a shape of an opening of the valve housing; wherein the outer edge is configured to securely position the valve seat plate in the opening; wherein a surface of the first side follows an outer shape of the shock absorber; and wherein the surface of the first side is configured to fit onto the shock absorber.

The valve housing may be a wall which is configured to incorporate a valve system and/or technical parts of a valve. The valve housing may be a cylinder shell which is open at one or both axial ends (opening). The shape of the valve housing may be narrower in the middle (of the axial direction, being narrower in the radial direction), preferably by 15 to 25%, most preferably around 20%. The valve housing may be made of metal, aluminum, steel or another material.

The valve seat plate may be configured to be positioned (just) inside one end of the valve housing. The shape of the outer edge following the shape of the opening of the valve housing may be press-fitted into the opening of the valve housing and in this manner be held within and possibly also sealing the opening. This has the advantage of the valve seat plate as such and/or its elongated hole being able to be bigger than in known configurations so that oil or oil flow restrictions are reduced. Thus, the valve seat plate does not need to be moved throughout the whole valve housing during assembly, but only into one end thereof. With reference to known constructions, it is noted that the valve housing is generally (first) welded to the tube of the shock absorber. Thereafter, the valve seat plate is inserted from or through the upper opening of the valve housing. In this context, the maximum dimensions of the valve seat plate are defined by the smallest inner diameter of the valve housing. Typically, such valve housings have a reduced inner diameter at those positions where the valve assembly is threaded or press-fitted or otherwise connected to the valve housing. In accordance with the present disclosure, the valve seat plate can be inserted into the lower opening of the valve housing before it is welded to the shock absorber. At this position, the material thickness of the valve housing can be reduced or even substantially reduced in comparison to the middle part of the housing comprising the threaded or press-fitted portions mentioned above. This allows for the use of a valve seat plate having a larger diameter, which in turn allows for a larger opening therein.

The outer edge is configured to securely position the valve seat plate in the opening. This may be achieved by the shape following the shape of the opening. It may be achieved by the valve seat plate being squeezed into the opening, especially when it is sealing. The secure positioning may mean that the valve seat plate is not able to turn or move much in the opening other than being introduced.

The elongated hole of the valve seat plate may be an elliptical hole, a hole that is not round, a hole with two round ends and a straight middle portion, or any other shape. The elongated hole may extend more into one direction than into the direction perpendicular thereto. The elongated hole may leave some material as border on all sides of the elongated hole towards the circumferences. The distance and/or mass of the border left may depend on the flow and/or pressure of the liquid. The border may be at least or exactly 4 mm thick, preferably at least or exactly 5 mm (“at least” because the border may not be uniformly wide). The elongated hole may be formed such that a sleeve of a valve seat with a round and/or cylindrical shape can pass through the elongated hole without fully blocking the elongated hole. In this manner, the elongated hole has the advantage of letting liquid pass in both directions, if possible even simultaneously: one direction may lead through the sleeve and the other direction may lead around the sleeve. The elongated hole has a further advantage of allowing for movement during assembly. Parts (like a sleeve) can move inside the elongated hole in at least one direction for adjustment during assembly.

The surface of the first side is configured to fit onto a tube of the shock absorber. In an embodiment, the shock absorber is flat and the first side is flat. In another embodiment, the shock absorber has a cylindrical shape and the first side is configured to fit onto the round outer side of this cylindrical shape. The first side may have the surface of a part of a cylinder cut out of the first side, meaning a recess and/or concave shape. Other embodiments are possible. In this manner the valve seat plate is configured to fit onto the shock absorber without leaving uneven spaces. This improves stability of the valve seat plate on the shock absorber in two ways: The valve seat plate is able to move less with respect to parts around it. Moreover, stabilization of parts of and/or forces on the second side of the valve seat plate is enhanced so that they can apply more pressure towards the valve seat plate itself. In other words, pressure on the other side of the valve seat plate can be larger without deforming the valve seat plate and/or the outer surface of the tube it rests on.

Preferably, the valve seat plate is configured to mechanically support a valve assembly of the shock absorber system together with and/or on the second side.

Preferably, the valve seat plate is further configured to endure a force of at least 5 kN, preferably at least 6 kN, more preferably at least 10 kN, from the valve assembly onto the valve seat plate.

Preferably, the shape of the outer edge is round and/or the first and second sides each have a round shape. Other shapes are possible, for example: square, rectangle and elliptical. The opening of the valve housing preferably has the same shape.

Optionally, a surface of the second side is flat, preferably it is completely flat.

Alternatively, the surface of the second side has a recess and/or a well. The surface of the second side may be adapted to shapes of the valve assembly. This may further increase stability by better supporting the valve system. The surface of the second side may have a fortification or a recess around the elongated hole. This may support the valve seat, especially a rim of the valve seat.

Preferably, the valve seat plate has a thickness of at least 3 mm, preferably of at least 5 mm, wherein the thickness of the valve seat plate is defined by a distance between the first side and the second side.

The distance between the first and second sides may be the closest distance between the sides or the furthest distance between the side. This may be especially different if at least one side is not flat.

Preferably, the elongated hole has a width of 12.0 to 13.5 mm, preferably 12.4 to 13.4 mm, most preferably 13.00 mm; wherein the elongated hole has a length of 25 to 31, preferably of 26.5 to 28.00, most preferably of 27.48 mm; and/or wherein the valve seat plate has a maximum diameter of 30 to 33 mm, preferably 32 mm.

In one embodiment, the elongated hole may have a width of 12.4 mm and a length of 27.3 mm.

Optionally, the valve seat plate is a single piece and solid.

The valve seat plate may be made of metal, steel, aluminum, plastic, an elastic fiber part, rubber, or any other material having the same or similar characteristics as the aforementioned materials. The valve seat plate may be made of the same material as the valve housing. In some embodiments, the valve seat plate is made of two or more components. Optionally, the valve seat plate may be produced by sintering.

In some embodiments, the valve housing and valve seat plate are integrally formed as a single piece component (not shown). This may be achieved by machining it from a solid piece of e.g. metal. Other manufacturing methods are also conceivable, such as forging, casting or combinations of different methods.

The disclosure also relates to a valve system comprising: the valve housing assembly as mentioned before; and a valve assembly arranged in the valve housing.

The valve assembly may be configured to be placed inside the valve housing and in contact with the valve seat plate. The valve assembly may comprise functional and/or technical parts of the valve.

Optionally, the valve assembly comprises an electronic valve.

Alternatively, the valve assembly may comprise a mechanical valve. In various embodiments, the (electronic or mechanic) valve may be comprised by the combination of valve assembly and valve housing. In various embodiments, the (electronic or mechanic) valve may be comprised by the combination of valve assembly, valve housing and valve seat plate.

Optionally, the valve assembly comprises an intake valve and an electronic valve.

Additionally or alternatively, the valve assembly may comprise at least one of: a valve seat with a tubular sleeve and a spring.

Optionally, the valve housing has a form of a cylinder shell; and the outer edge of the valve seat plate is configured to fit into one end of the valve housing.

Optionally, the one end of the valve housing is free of threading and/or press-fit areas for the valve assembly. This one end is preferably the end that is configured to receive the valve seat plate. Without threading and/or press-fit area for the valve assembly, the material thickness of the one end of the valve housing, thereby allowing for a larger inner diameter such that the valve seat plate may be received more easily and the valve seat plate may be bigger (diameter of sides) because it does not need to fit through the threading and/or press-fit area.

The disclosure also relates to a shock absorber system comprising: the valve system described above; and a shock absorber.

Optionally, the shock absorber has a cylindrical shape. The surface of the first side of the valve seat plate may be formed to fit onto an outer round part of the cylindrical shape.

Optionally, the valve seat plate is located between the valve assembly and the shock absorber. The valve housing may surround the valve seat plate and the valve assembly, and/or wherein the valve assembly may be mechanically supported by the valve seat plate.

Further, the valve seat plate may be configured to be in direct contact with the shock absorber.

Optionally, the valve seat comprises a sleeve reaching from inside the valve housing through the elongated hole of the valve seat plate into the shock absorber, and a rim, which is supported by the valve seat plate.

The sleeve may be a hollow tube. The sleeve may be configured to let liquid flow through it from the shock absorber to the inside of the valve. The valve seat may comprise the sleeve that may be attached to the rim at an end inside the valve housing. This rim may be in direct contact with the second side of the valve seat plate.

Optionally, the width of the elongated hole may be bigger than an outer diameter of the sleeve.

The width and length of the elongated hole may be bigger than the outer diameter of the sleeve. The rim of the valve seat may still hold to the valve seat plate, when the rim is bigger than the width of the elongated hole. Alternatively, the sleeve may be held by another part of the valve system to not fall through the elongated hole.

Optionally, the valve system is a first valve system; the shock absorber system may further comprise a second valve system as described above; wherein one of the first and the second valve system is configured for compression of the shock absorber, and wherein the other of the first and second valve system is configured for rebound of the shock absorber.

The two valve systems may comprise corresponding valves. The two valve systems (and valves) do not need to be identical, but they may be identical. Alternatively, the shock absorber system has only one valve.

The disclosure also relates to a method for assembling a shock absorber system, the shock absorber system comprising a shock absorber, a valve and a valve housing assembly as explained above, the method comprising: preassembling the valve seat plate into the valve housing at an open end of the valve housing, and then attaching the valve housing to the shock absorber thereby enclosing the valve seat plate.

Attaching the valve housing to the shock absorber may be done by welding or similar fastening techniques.

Optionally, the method further comprises: introducing technical valve elements into the valve housing; and providing direct contact between the technical valve elements and the valve seat plate.

The technical valve elements may be the valve system. The technical valve elements may apply force/pressure onto the valve seat plate. The valve seat plate can better handle such force/pressure.

### DESCRIPTION OF THE DRAWINGS

The disclosure and further details and advantages thereof are explained below with reference to the figures using preferred embodiments, with identical designations denoting identical elements. The figures show:

FIG. 1 depicts a valve seat plate;

FIG. 2 shows two perspectives of a valve housing assembly comprising the valve seat plate and a valve housing;

FIG. 3 depicts a valve housing assembly on a wall of a shock absorber;

FIG. 4 depicts a valve housing assembly on a wall of a shock absorber in an isometric view;

FIG. 5 shows a cross section of a valve housing assembly on a wall of a shock absorber; and

FIG. 6 shows a flowchart of a method.

### DETAILED DESCRIPTION

In the present description, the expressions top, bottom, right and left and similar indications refer to the orientations or arrangements shown in the figures and serve only to describe the embodiments. These expressions may show preferred arrangements, but are not to be understood in a restrictive sense.

Furthermore, the expressions “substantially”, “approximately”, “about” and similar expressions mean that deviations of +/-10%, preferably +/-5%, from the stated value are permissible.

Unless explicitly excluded, the value ranges mentioned above are always understood in such a way that lower edge areas with “≥”, greater than or equal to, and upper edge areas with “≤”, less than or equal to, are considered to be included in the mentioned value range. In particular, the edge areas themselves are therefore either included in the respective range, but can alternatively also be (unilaterally) excluded.

Features which are identical in several figures are not explained each time again. It is referred to the description of an earlier figure, respectively.

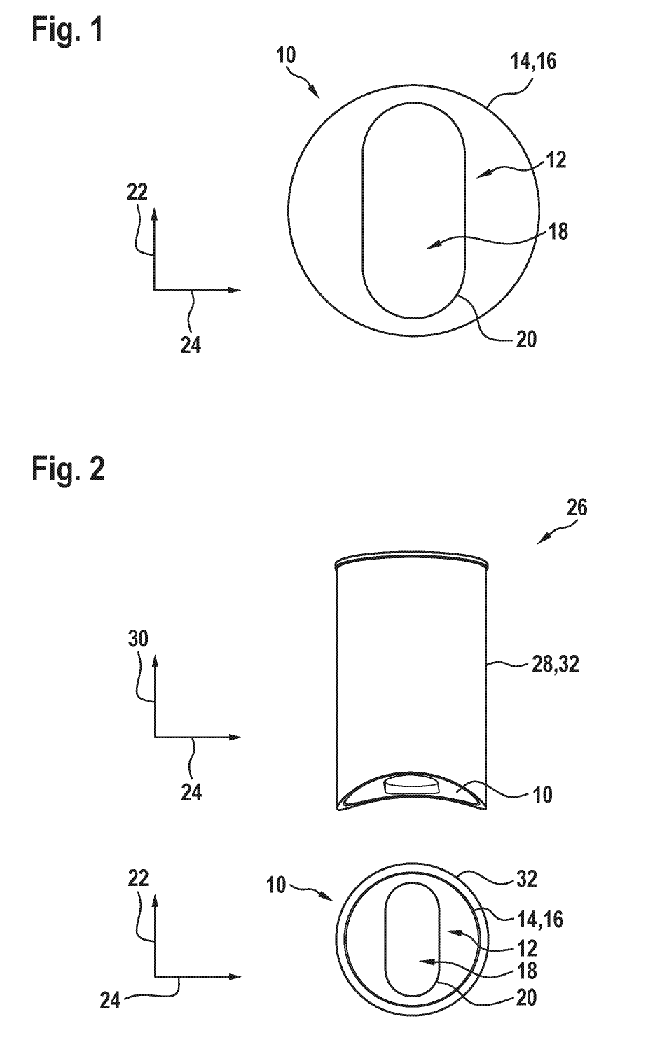

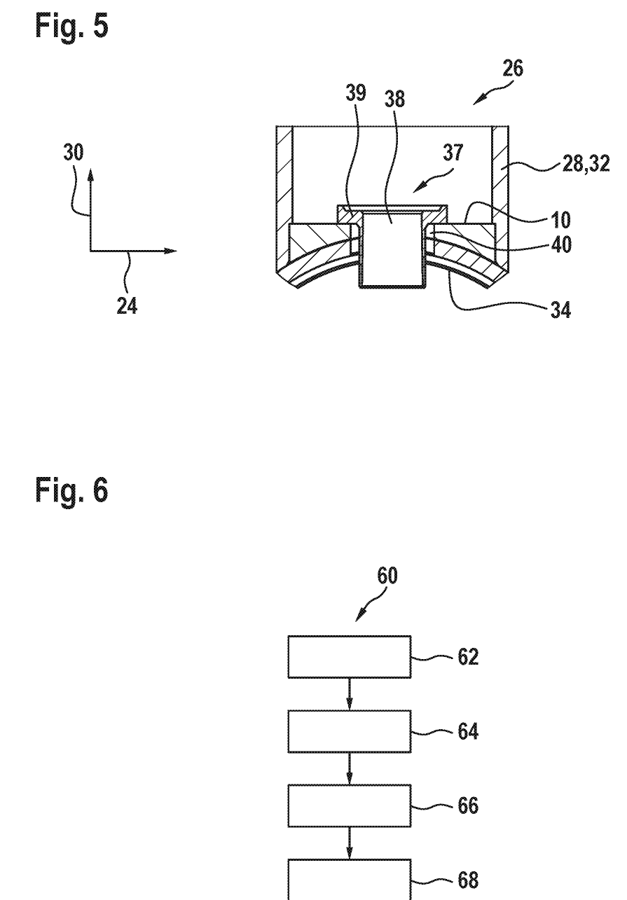

FIG. 1 shows a valve seat plate 10 in a top view. The valve seat plate 10 has a first side 12, a circumference 14, an outer edge 16, an elongated hole 18, and an edge 20 of the elongated hole 18. The outer edge 16, as depicted here, is round, which renders the first side 12 round as well. Other shapes, for instance oval or elliptic, are also possible. As depicted, the elongated hole 18 does not reach all the way to the outer edge 16, thus leaving some material of the first side 12 in all directions (border), respectively. The elongated hole 18 comprises a length in a first direction 22 and a width in a second direction 24, wherein the length in the first direction 22 is at least twice the width in the second direction 24. Optionally, the length in the first direction 22 may be between 2,0 to 2,5, preferably between 2,1 to 2,4 or 2,18 times bigger than the width in the second direction 24. A second side (not shown in FIG. 1, but in FIG. 5) of the valve seat plate 10 is positioned, relatively to the first side 12, in a third direction 30, which is perpendicular to both the first direction 22 and the second direction 24. The valve seat plate 10 has a compact geometry, which provides for stability.

The elongated hole 18 of FIG. 1 comprises two (half-)round end portions and a straight middle portion. The straight middle portion comprises two parallel sides (of the edge 20). This may be advantageous in that a rim 39 of a valve seat 37 of a valve assembly can move along the straight middle portion without changing the quality of support being constantly provided by the valve seat plate 10 (see FIG. 5 as described in detail below).

FIG. 2 shows two perspectives (in the following: upper and lower part of FIG. 2, wherein the lower part of FIG. 2 is rotated about 90 degrees with respect to the upper part) of a valve housing assembly 26 comprising the valve seat plate 10 in a side view (upper part) and in a top view (lower part). FIG. 2 shows again the first side 12 of the valve seat plate 10. The upper part of FIG. 2 further shows a valve housing 28 having a cylindrical shell 32.

As depicted in the upper part, the valve seat plate 10 is positioned at an end of the valve housing 28 and inside the valve housing 28. The outer edge 16 follows the shape of the cylindrical shell 32. Further, the surface of the first side 12 has a concave shape (i.e. concave in one dimension of the first direction 24, bending towards the third direction 30). The concave shape is configured to fit onto a tube of a shock absorber.

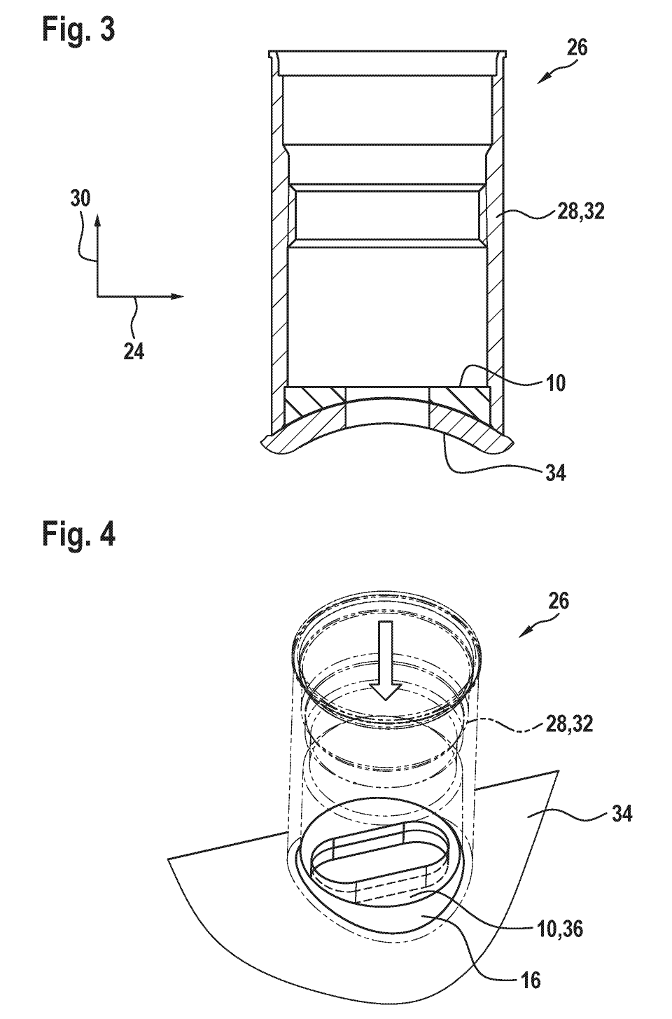

FIG. 3 shows another valve housing assembly 26, here positioned or mounted on a wall of a shock absorber 34. The valve seat plate 10 is in direct contact with the shock absorber 34. The valve housing assembly 26 may comprise a valve system positioned inside the valve housing 28.

The valve system may be mechanically supported by the valve seat plate 10, which again may be supported by a wall of the shock absorber 34. The term “supported by” may mean a forced act or action between the two parts for instance by form fit, respectively. Such support may be especially advantageous for a crash land sealing. The valve housing 28 may be connected to the wall of the shock absorber 34 by welding or in any other way, which is compatible with the present disclosure. The specific form of the valve seat plate 10 is also configured to support the structure of the shock absorber 34 (damper).

An inner shape or contour of the valve housing 28 as depicted in FIG. 3 may be purely non-cylindrical. A middle part (in view of the third direction 30) of the valve housing 28 is narrower in width than both outer parts (also in view of the third direction 30) of the valve housing 28. The narrower middle part may comprise threading and/or press-fit areas for securing a valve assembly to the valve housing 28. Since the valve seat plate 10 as depicted would not fit through the narrower middle part (inside), the valve seat plate 10 is placed inside the valve housing 28 before the valve housing 28 is fixed to the wall of the shock absorber 34. Due to such an assembly sequence, the valve seat plate 10 can be bigger than for instance the shock absorber 34. This provides better support for the valve system as a whole.

In FIG. 3, the valve seat plate 10 is preferably positioned inside the housing 28. In fact, it is flush with the housing 28. The lower surface of the valve seat plate 10 is a concave surface as described with respect to FIG. 2.

FIG. 4 shows another valve housing assembly 26 positioned on a wall of a shock absorber 34 in an isometric view. The valve housing 28 is shown in see through mode. The valve seat plate 10 is positioned inside the valve housing 28. The valve seat plate 10 fits onto the wall of the shock absorber 34 and follows the shape of the valve housing 28 (round in this case). The flat side of the valve seat plate 10 as shown is the second side 36. The valve system may be positioned on this second side 36. The outer edge 16 of the valve seat plate 10 can be seen at the circumference of the second side 36. The outer edge 16 extends in directions perpendicular to the second side 36.

FIG. 5 shows a cross section of another valve housing assembly 26 positioned on a wall of a shock absorber 34. The valve seat plate 10 is positioned inside the valve housing 28 and supports a valve seat 37 having a sleeve 38 (tube) and a rim 39. The sleeve 38 reaches from inside the valve housing 28 through the elongated hole 18 into the shock absorber 34.

In operation, i.e. when a shock is to be absorbed by the shock absorber 34, fluid within the shock absorber 34 flows via the sleeve 38 through a respective valve into another chamber. The shock absorber 34 and therefore also the valve housing assembly 26 may be operated in two different oil strokes, i.e. either compression or rebound, thus, the fluid either flows into the other chamber through the elongated hole 18 outside the sleeve 38; or the fluid flows later on from the other chamber back into the shock absorber 34 through the elongated hole 18 outside the sleeve 38 (as a back-flow opening).

The sleeve 38 may be sealed in the shock absorber 34 via an O-ring 40.

FIG. 6 shows a flowchart of a method 60 for assembling a shock absorber system, the shock absorber system comprising a shock absorber 34, a valve and a valve housing assembly 26, as explained above. The method 60 comprises several steps.

In step 62, the valve seat plate 10 is preassembled into the valve housing 28 at an open end of the valve housing 28. At step 64, the valve housing 28 is attached to the shock absorber 34 thereby enclosing the valve seat plate 10. Attaching the valve housing to the shock absorber may be done by e.g. welding. Preferably, the method further comprises step 66 of introducing technical valve elements into the valve housing 28; and step 68 of providing direct contact between the technical valve elements and the valve seat plate 10.

The valve seat plate 10 together with the elongated hole 18 can improve assembly of the valve housing assembly 26 to the shock absorber 34. Movement of parts is possible due to the elongated nature of the elongated hole 18. Further, the valve seat plate 10 stabilizes the valve housing 28 during connecting it to the shock absorber 34. Further, the valve seat plate 10 supports the valve system.

The disclosure has been described with reference to preferred embodiments, whereby the individual features of the embodiments described can be freely combined with one another and/or interchanged, if they are compatible. Likewise, individual features of the described embodiments can be omitted if they are not absolutely necessary. Numerous modifications and embodiments are possible and obvious to the person skilled in the art without departing from the appended claims.

1. A valve housing assembly for a shock absorber system, the valve housing assembly comprising a valve housing and a valve seat plate, the valve seat plate comprising:
a first side, a second side opposite of the first side, an outer edge at corresponding circumferences of each of the first and second side, and an elongated hole between the first side and the second side;
wherein a shape of the outer edge follows a shape of an opening of the valve housing;
wherein the outer edge is configured to securely position the valve seat plate in the opening;
wherein a surface of the first side follows an outer shape of the shock absorber; and
wherein the surface of the first side is configured to fit onto the shock absorber.

2. The valve housing assembly according to claim 1, wherein the valve seat plate is configured to mechanically support a valve assembly of the shock absorber system together with and/or on the second side;
wherein preferably the valve seat plate is further configured to endure a force of at least 5 kN, preferably at least 6 kN, more preferably at least 10 kN, from the valve assembly onto the valve seat plate.

3. The valve housing assembly according to claim 1, wherein the shape of the outer edge is round and wherein the first and second sides each have a round shape;
wherein preferably a surface of the second side is flat.

4. The valve housing assembly according to claim 1, wherein the valve seat plate has a thickness of at least 3 mm, preferably of at least 5 mm;
wherein the thickness of the valve seat plate is defined by a distance between the first side and the second side; and/or
wherein the valve seat plate is a single piece and solid.

5. The valve housing assembly according to claim 1, wherein the elongated hole has a width of 12.0 to 13.5 mm, preferably 12.4 to 13.4 mm, most preferably 13.00 mm;
wherein the elongated hole has a length of 25 to 31, preferably of 26.5 to 28.00, most preferably of 27.48 mm; and/or
wherein the valve seat plate has a maximum diameter of 30 to 33 mm, preferably 32 mm.

6. The valve housing assembly according to claim 1, further comprising a valve seat;
wherein the valve seat comprises a sleeve, preferably reaching from inside the valve housing through the elongated hole of the valve seat plate into the shock absorber, and a rim, preferably being supported by the valve seat plate.

7. The valve housing assembly according to claim 6, wherein the width of the elongated hole is bigger than an outer diameter of the sleeve.

8. A valve system comprising:
the valve housing assembly of claim 1; and
a valve assembly arranged in the valve housing;
wherein preferably the valve assembly comprises an intake valve and/or an electronic valve.

9. The valve system of claim 8, wherein:
the valve housing has a form of a cylinder shell;
the outer edge of the valve seat plate is configured to fit into one end of the valve housing; and
the one end of the valve housing preferably is free of threading and/or press-fit areas for the valve assembly.

10. A shock absorber system comprising:
the valve system of claim 8; and
a shock absorber that preferably has a cylindrical shape and wherein preferably the surface of the first side of the valve seat plate is formed to fit onto an outer round part of the cylindrical shape.

11. A shock absorber system comprising:
the valve system of claim 8; and
a shock absorber;
wherein the valve seat plate is located between the valve assembly and the shock absorber;
wherein the valve housing surrounds the valve seat plate and the valve assembly; and
wherein the valve assembly is mechanically supported by the valve seat plate.

12. A shock absorber system comprising:
the valve system of claim 8; and
a shock absorber;
wherein the valve system is a first valve system;
wherein the shock absorber system further comprises a second valve system according to the valve system of claim 8;
wherein one of the first and the second valve systems is configured for compression of the shock absorber; and
wherein the other of the first and second valve systems is configured for rebound of the shock absorber.

13. A method for assembling a shock absorber system, the shock absorber system comprising a shock absorber, a valve and a valve housing assembly according to claim 1, the method comprising:
preassembling the valve seat plate into the valve housing at an open end of the valve housing; and
then attaching the valve housing to the shock absorber thereby enclosing the valve seat plate;
the method preferably further comprising:
introducing technical valve elements into the valve housing; and
providing direct contact between the technical valve elements and the valve seat plate.
